(19) United States
(12) Patent Application Publication
(10) Pub. No.: US 2021/0224935 A1
(43) Pub. Date: Jul. 22, 2021

(54) REAL ESTATE COMMUNICATIONS SYSTEM AND METHOD FOR DISTRIBUTING REAL ESTATE LISTING INFORMATION, AND COLLECTING COMMITMENT INFORMATION

(71) Applicant: Matt PROMAN, Newport Beach, CA (US)

(72) Inventor: Matt PROMAN, Newport Beach, CA (US)

(21) Appl. No.: 16/995,752

(22) Filed: Aug. 17, 2020

Related U.S. Application Data
(60) Provisional application No. 62/888,499, filed on Aug. 18, 2019.

(51) Int. Cl. G06Q 50/16; G06Q 30/08; G06F 16/29

(52) U.S. Cl. CPC G06Q 50/167; G06F 16/29; G06Q 30/08

(57) ABSTRACT

The present invention provides a method for receiving and storing a plurality of property identifications, sets of attributes, plurality of owner communication addresses, and associative information, in a property database. Receiving and storing broker identifications, sets of broker attributes, broker communication addresses and broker associative information; in a broker database. Providing property identifications with property attributes associated with each provided property identification to brokers. Receiving a bid to secure a listing broker representation for the sale or rental of a particular property, the bid being associated with bid information; fixed bid/monetary bid; with potential listing broker information; storing said bid information associated with a property identification and a broker identification in a bid information database; and communicating the bid information to the owner of the associated property together with a broker identification and broker attributes.

### TECHNICAL FIELD

The invention relates to an apparatus and method for assisting homeowners in implementing real estate listings and selling or renting out real property.

### CROSS REFERENCE TO RELATED APPLICATIONS

This application claims the benefit of U.S. Provisional Patent Application No. 62/888,499, filed Aug. 18, 2019, entitled Real Estate Communications System and Method for Distributing Real Estate Listing Information, and Collecting Commitment Information, the disclosure of which is hereby incorporated herein by reference.

### STATEMENT REGARDING FEDERALLY SPONSORED RESEARCH OR DEVELOPMENT

(Not applicable)

### BACKGROUND OF THE INVENTION

Conventionally, when an individual decides to sell real property, for example a home, success in obtaining a good price within a reasonable amount of time correlated to the degree of exposure of the availability of the property to potential buyers. This was often achieved by widely advertising the property in the general geographical area within which the property was located. Seeking to obtain an additional degree of exposure, many sellers sought the assistance of a real estate agent. Employing a real estate agent, while in telling the payment of a commission, could dramatically increase the probability of a sale at a good price, for example where an agent had a strong reputation or a large following, or worked hard and advertise widely to turn up leads on potential buyers. Under an arrangement of this sort, a trusted broker is given a period of exclusivity, for example 3 to 6 months within which to sell the property. An individual with this exclusive agreement is often referred to as the “listing broker.”

It is noted that the terms “realtor,” “listing broker,” “broker,” “agent” and so forth are used in different ways by different persons, particularly lay persons. Notwithstanding the terminology used herein the general principles of the inventive communications apparatus are meant to facilitate communications and the execution of tasks involving the owner of a property such as a house, apartment or boat and those professionals assisting in the sale or rental of the same.

Traditionally, listing brokers have sought to increase their effectiveness by joining a multiple listing service (“MLS”). Under such an arrangement, a package of services is provided to real estate brokers to allow them to establish contractual offers of compensation among brokers, allows each of them to see one another's listings of properties for sale and enable a number of brokers to attempt to sell a particular property, as well as to accumulate and disseminate information to enable appraisals.

If a property is marketed under a multiple listing service, the commission is shared between the buy side broker and the seller's broker. As a first step, the total compensation amount is typically determined by the seller and the seller's broker. Generally, the seller's broker, as the listing broker, then advises all other MLS participants what the amount of compensation to the buyer's broker will be. Compensation to the buyer's broker can take the form of a percentage of the sales price or a fixed dollar amount. However, a buyer's broker is free to negotiate the amount of the commission with the seller's broker.

Today, Internet-based services are used to expand marketing activities on the basis of these principles. Generally, enterprises operating real estate databases make information respecting properties (such as location, asking sales price, listing agents and so forth) more widely available thus increasing the likelihood of a sale at a good price within a reasonable period of time. Typically, the real estate databases gather information by attracting buyers, sellers, landlords and potential tenants to their website and collecting information useful in facilitating a real estate transaction. In addition, database operators access multiple listing services to collect additional information, to further enable their goal of providing information aimed at facilitating the consummation of real estate transactions.

As a general rule, database operators charge nothing to the buyer or seller or their agents for the sales which they enable. However, they do generate income by banner advertising, the sale of apps and other services.

### SUMMARY OF THE INVENTION

While Internet-based services of the type described above are useful in facilitating the dissemination of information, they are inherently incapable of providing personalized services of the type which may be focused on the sale of a particular property. Such activities essentially remain within the exclusive purview of the listing broker. Accordingly, obtaining a listing broker with the economic muscle to market a property and a commitment to vigorously do the same are critical to a seller's or landlord's obtaining a good price within a reasonable period of time.

While, for purposes of illustration, this specification often makes reference to a real estate buyer and seller, it is understood that this is merely an example of the application of the invention which may also be applied to the renting of properties by landlords to tenants.

The importance of the seller or landlord retaining a very effective listing broker is underscored by several potential scenarios which will inhibit obtaining a good price within a reasonable period of time. For example, a listing broker may not have the financial resources to advertise the property. If the listing broker has a limited number of properties, he may be tempted to keep the listing to himself and only sell it to buyers who approach him or his agency directly, thus ensuring that such a listing broker retains the entire commission. However, the most insidious possibility is that the listing broker will focus his efforts on accumulating a large number of listings, put them out over the multiple listing service, and then just wait for other brokers to do the work and incur the expenses associated with finding buyers.

The crux of the problem is that real estate market has a relatively complex structure and the fairness of the arrangement between the listing broker and the seller/landlord can affect the effectiveness of the marketing effort. For example, a fair commission can be the to depend upon whether it is a buyers market or a sellers market for the particular interest in real property involved. Moreover, fairness can be easily compromised due to the imperfect nature of the market involved, in so far as real estate brokers typically have much more information about current than expected market factors as compared to homeowners and even many, particularly smaller, landlords.

In accordance with the invention, it has been recognized that a marketplace which facilitates the formation of relationships between listing brokers and sellers, not just on the basis of property information but also on other bases, for example the full spectrum of market factors and individual potential listing broker characteristics, will better serve the objective, within the context of a real estate communications system, of achieving consummation of a greater proportion of real estate transactions at good prices within a reasonable period of time.

The inventive method, comprises receiving a plurality of property identifications associated with a plurality of properties and storing the property identifications in a property database. A plurality of sets of property attributes, each of the sets of property attributes being associated with an associated one of the plurality of properties are received and stored in the property database with associative information associating each particular set of property attributes with its associated property. A plurality of owner communication addresses, each of the owner communication addresses being associated with an associated one of the plurality of properties are receive and stored in a property owner address database with property associative information associating each owner communication address with its associated property. A plurality of broker identifications each associated with a particular broker are received and stored in a broker database. A plurality of sets of broker attributes, each of the sets of listing broker attributes being associated with an associated one of the brokers are received and stored in the broker database with broker associative information associating each particular set of broker attributes with its associated broker. A plurality of broker communication addresses, each of the broker communication addresses being associated with an associated one of the plurality of brokers. Each broker communication address is received and stored in a broker communication address database with broker communication address associative information associating each broker communication address with its associated property. One or more property identifications each with a partial or complete set of the property attributes associated with each provided property identification to brokers are provided. The inventive system receives from a plurality of brokers, provided with one or more property identifications each with a partial or complete set of the property attributes, a bid to secure a listing broker representation for the sale or rental of a particular property, the bid being associated with bid information. The same may be a fixed bid/monetary bid and may include potential listing broker information. The bid information associated with a property identification and a broker identification may be stored in a bid information database. The bid information is communicated to the owner of the associated property together with a broker identification and broker attributes.

Optionally each of the sets of property attributes comprise a plurality of individual property attributes, such as a price, a geographical indicator and a physical feature, the property database divided into a plurality of property attribute sectors, wherein each of the individual property attributes is dedicated to storing one of the individual property attributes.

Optionally the providing one or more property identifications each with a partial or complete set of the property attributes associated with each provided property identification to brokers is performed by receiving from a searching broker a number of search criteria indicating searching broker selected individual property attributes and searching broker selected qualitative and/or quantitative characteristics, searching the property database and identifying potential properties of interest to the searching broker.

### BRIEF DESCRIPTION OF THE DRAWINGS

The operation of the inventive system will become apparent from the following description taken in conjunction with the drawings, in which:

FIG. 1 is a flow chart generally illustrating the methodology of a general implementation of the present invention;

FIG. 2 is a block diagram illustrating an exemplary embodiment of the infrastructure for implementing the presentation as illustrated in FIG. 1.

### DETAILED DESCRIPTION OF THE PREFERRED EMBODIMENTS

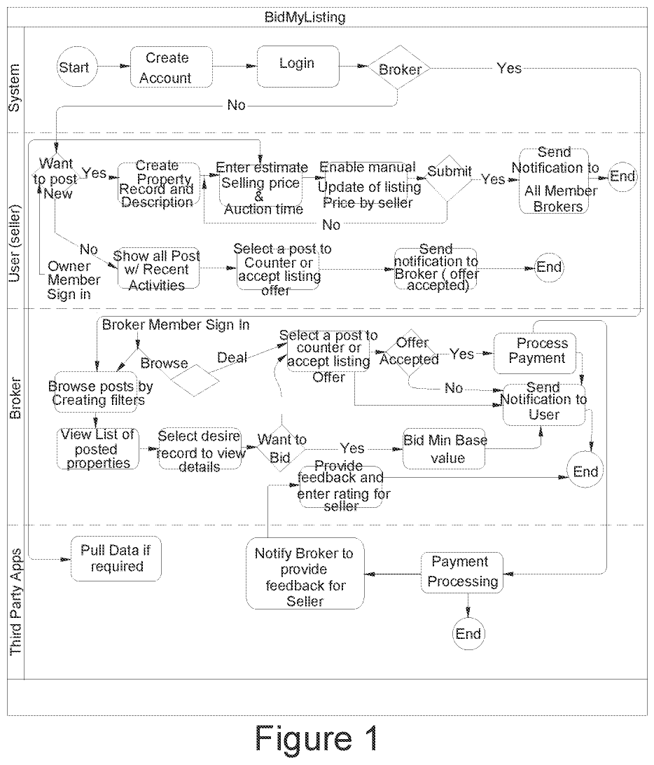

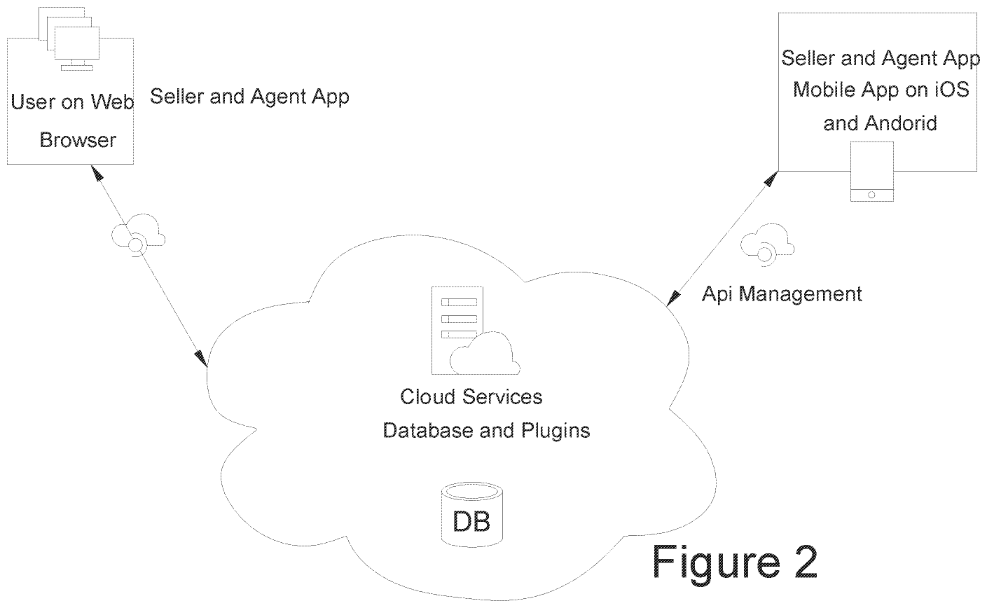

In accordance with the invention, as diagrammed in FIGS. 1 and 2, both homeowners and real estate agents and brokers are provided with a trading platform capable of nationwide and/or international reach. More particularly, the inventive system provides an infrastructure for the valuation of agent interest, agent information collection and transmission, and a mechanism for the making of performance-enhanced contracts for the exclusive and non exclusive listing agreements for buying and selling, leasing out and leasing of residential and commercial real estate. More particularly, the inventive method bidding-like/auction-like information exchanges, offers and acceptances with the object of implementing performance-enhanced contracts for the exclusive and non exclusive listing agreements.

The result is to provide the numerous benefits to both homeowners and commercial real estate agents and brokers. In this specification, it is to be understood that references to selling transactions between a seller and buyer are to be understood as applicable to analogous transactions, that is, for example, applicable to leasing transactions between lessors and lessees, and vice versa.

In accordance with the invention, the seller or lessor posts a home or other property on either a web platform or using an app. The posting includes a description of the listing including but not limited to such things as home value, home listing price, suggested starting bidding price, location, photos, videos, square footage, number of bedrooms and bathrooms, school district, taxes, and so forth.

The posting of the seller's home or property made available to all real estate agents (or optionally a selected group of real estate agents, for example, subscribers to the inventive system). Optionally, the posting can be made available worldwide or in a limited geographic region. Upon accessing a posting, a real estate agent is given the opportunity to bid on or buy the rights to an exclusive or non exclusive right to represent the owner in the selling or leasing of the home or property for an agreed upon period of time, for example periods of time ranging from three months to 24 months. Optionally, the exclusivity may be limited to sales above a set price, leaving the owner to make a sale at a lower price.

In accordance with the preferred embodiment, the inventive system comprising website and communications infrastructure, or alternatively an app enabled over the Internet, although it goes beyond an information exchange capacity and implements actions associated with a sale (for example, sale of a right to sell), is not involved in any capacity in the actual buying and selling of the home or other property. Moreover, it achieves the same for real estate agents and sellers by acting, effectively as a platform to buy and sell the listing agreements at fair market value in a bidding-like process.

In accordance with the invention, a seller is able to monetize as an asset his listing agreement. He is thus paid for assigning to a real estate agent the right to sell or lease a property or home. This compensation to the homeowner or property owner, which is optimized on the inventive platform, is in lieu of the traditional approach of the seller giving the listing agreement to a real estate agent or investor at no cost.

Thus, the seller now is able to showcase a home in front of real estate agents and investors, for example, worldwide, to bid on or outright buy the rights to listings. This ensures that the seller engages an agent or investor who has an economic investment in seeing the home or property sell. It also potentially can attract only agents who believe they can efficiently sell the home or property.

This process de risks the sellers exposure to hiring the wrong real estate agent to sell their home or property. The premise is based on the implications when a real estate agent is ready to invest his own money into buying the right to sell or lease a home or property, including an implication that the agent has made an assessment that there can be a successful effort.

With the benefit of the inventive system, investors and real estate agents can access potential clients without the cost of the traditional advertising of their services to the masses of people, only a few of whom may looking for their services. Instead, financial resources can be used to invest in the exact inventory they are most likely to be able to monetize and on advertising and other efforts more likely correlated to their client's needs and objectives.

While today many real estate agents build their business other than general advertising, for example by “referrals” or “word of mouth,” such efforts are not predictable or scalable. The inventive system allows real estate agents the ability to access and buy potential inventory while providing a direct economic benefit to the seller. It also provides the seller with a real estate agent who is enhancedly motivated to achieve seller objectives due to monetary investment in the same, particularly when exclusivity is time limited. The inventive infrastructure makes possible novel matrices of relationships which may vary over time and allow high performing agents the opportunity to better serve owners and investors.

Certain aspects of one embodiment of the invention may be better understood from the following. More particularly, the following conceptual formula for this embodiment of the inventive system is a bidding equation that is likely to derive an optimal sales price for a seller to ask for based on commissions and length of property sale. The inclusion of a formula of this type, or a partial or full substantial equivalent thereof, has as its objective to determine an optimal start bid or bid range for a property for sale. The formulae disclosed herein is related to equations derived by Professors Roger Myerson and Professor Vickrey, but has been modified by the inventors for the purpose of the objectives of the inventive system. More particularly the objective is to adopt the inventive system to external factors added to modify a result meant to approximate an optimal bid.

Consider the problem faced by someone who has a real estate listing, but who does not know how much the prospective buyers would pay for that listing. This seller would like to use an app where this number is pre-determined for the seller so that the seller can benefit from the greatest possible expected revenue. This formulae outlined herein is meant for application to real time auctions, progressive auctions, sealed bid auctions, and discriminatory auctions.

In the case of the inventive system, the objective is not to get the highest possible bid but rather the most optimal bid. The bid will change when factors such as commissions and length of listings are added. This is the key differentiator in the inventive process.

To analyze the potential performance of different kinds of auctions, one regards the auctions as noncooperative games with imperfect information. The invention proceeds from the presumption that a seller faces N potential brokers numbered 1, 2, etc., where N represents the set of brokers who are the bidders in this case.

N={1, . . . , <<} (2.1)

As an aside, it is noted that the approach could also be used where the formula could be used by another application where the bidder is not necessarily a bidder but rather the buyer.

Returning to the current analysis, seller's problem derives from the fact that he does not know how much the various bidders are willing to pay for the listings. That is, for each bidder, there is some quantity and which represents the maximum amount which the bidder would be willing to pay for the listing given his current information about the listing. The inventive system proceeds from the assumption that the seller's uncertainty about the value estimate of the bidder can be described by a continuous probability distribution over a finite interval.

The formulae consider the set of all possible combinations of bidders' value estimates, as well as the commissions and length of time of a listing. The inventive system may optionally consider the seller's personal value estimate of the listing.

There are two general reasons why one bidder's value estimates may be unknown to the seller and the other bidders. First, the bidder's personal preferences might be unknown to the other agents. For example, the buyer might not know evidently the amount of renovations which have gone into the property, proximity to new desirable factors such as schools, or shopping venues, etc.

This distinction is significant. If there are only preference uncertainties, then informing the bidder about the seller's value estimate should not cause the bidder to revise his valuation. (This does not mean that the bidder might not revise his bidding strategy in an auction if he knew Buyer's value estimate. Rather, this means only that Seller's honest preferences for having money versus having the listing would not change.

By way of explanation, the inventive system works based on the following. A real estate broker that essentially agrees to advance a portion of their commission in order to obtain a listing. As a matter of practicality, perhaps the most a real estate agent can offer will be less than half of the expected commission given that if the commission is 4% on average and they don't end up selling the house but somebody else does then they'll have to split the commission with another party (in accordance with customary procedures which could, of course, be varied between individual agents, at least in principle).’

If one considers the case where a broker has three listings which are obtained through the inventive system, the following situation may apply and functions as an example of a possible set of transactions. In this example, the first listing is for 3%, the second is for 4%, and the third one is for 5%. The broker sells the first listing through another buyer and therefore has made a 1.5% commission. The broker sells house number 2 directly and therefore collects the entire 3% commission. Finally, the broker sells house number 3 for 5% commission but splits it with another realtor and therefore makes half the commission as well. In the case of house number 1, the broker must offer something less than 1% commission because if he offered any more than that his revenue numbers would be rather diminutive since he didn't sell the property. On the flip side, the seller might not be happy with a 3% commission rate and does not have any consideration for the Brokers needs and the Brokers expenditures. Most sellers, in fact most all sellers are substantially unconcerned with the Broker's expenditures, etc.

In accordance with a particularly preferred embodiment of the invention, the operator of the inventive system (“system operator”) pays an agreed to amount of compensation to, for example, a homeowner. The homeowner agrees that for a period of, for example, thirty days the system operator has the right to make an agreement appointing a real estate agent to represent the homeowner in, for example, the sale or leasing of the property. Of course other periods of time may be employed, such as a 60 day bidding period.

During that thirty day period, the system operator lists information regarding the property and the nature of the engagement desired by the homeowner on the system and makes the same available to real estate agent subscribers to the platform provided by the inventive system. During that thirty day period, real estate agent subscribers bid for the homeowner's listing.

In accordance with a particularly preferred embodiment of the invention, the homeowner is advised of bids as they occur, for example by email. Alternatively, bids may be reported periodically, for example once a day by email. Yet another alternative is to make bidding information available to the homeowner by posting the same on the account of the homeowner on the inventive system.

Optionally, at any point during the bidding process, the homeowner can stop the process by accepting a bid. It is contemplated that bid information sent to the homeowner may include such things as the duration of exclusivity that the real estate agent is seeking, the commission that the real estate agent is seeking, the identity of the real estate agent, office locations, number of agents, and so forth.

In accordance with the invention, it is contemplated that the homeowner will specify certain criteria, for example, such parameters as the duration of exclusivity that the real estate agent will be given, the commission that the real estate agent will receive when the property is sold, and so forth. At the end of the thirty day period, if the homeowner has not accepted one of the bids made by the real estate agents, the system evaluates bids made and selects the closest match to the parameters specified by the homeowner, and gives the closest matching real estate agent the right to represent the property for the agreed to period of time, commission and so forth.

In accordance with one embodiment of the invention, it is contemplated that the homeowner is paid the agreed to compensation at the time that the homeowner engages the system operator. The agreed to compensation is paid by the system operator. Alternatively, the agreed to compensation may be paid upon the acceptance of a bid or the end of the thirty day period.

In accordance with the invention, it is contemplated that the system will be funded by real estate agents who pay the system operator for the information gathering services provided by the system operator. Such payment may take the form of a yearly membership, or payments made for the successful use of information provided by the system operator, for example, use of that information by the real estate agent in the form of the real estate agent accepting the representation of the homeowner. In accordance with the invention it is contemplated that the information gathering fee paid by the real estate agent is not refundable to the real estate agent in so far as potentially valuable information has been provided by the system operator.

In accordance with the invention, it is contemplated that the fees paid by real estate will exceed the compensation paid to homeowners, for example, either on a transaction by transaction basis or on the business of the system operator, as a whole. For example, on a given transaction, the information gathering fee paid by the real estate agent to the system operator may amount to 120% of the compensation paid by homeowners and other users of the inventive system.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed:

1. A method, comprising:
(a) receiving a plurality of property identifications associated with a plurality of properties and storing said property identifications in a property database;
(b) receiving a plurality of sets of property attributes, each of said sets of property attributes being associated with an associated one of said plurality of properties and storing said sets of property attributes in said property database with associative information associating each particular set of property attributes with its associated property;
(c) receiving a plurality of owner communication addresses, each of said owner communication addresses being associated with an associated one of said plurality of properties and storing each owner communication address in a property owner address database with property associative information associating each owner communication address with its associated property;
(d) receiving a plurality of broker identifications each associated with a particular broker and storing said broker identifications in a broker database;
(e) receiving a plurality of sets of broker attributes, each of said sets of listing broker attributes being associated with an associated one of said brokers and storing said sets of broker attributes in said broker database with broker associative information associating each particular set of broker attributes with its associated broker; attributes comprise;
(f) receiving a plurality of broker communication addresses, each of said broker communication addresses being associated with an associated one of said plurality of brokers and storing each broker communication address in a broker communication address database with broker communication address associative information associating each broker communication address with its associated property;
(g) providing one or more property identifications each with a partial or complete set of the property attributes associated with each provided property identification to brokers;
(h) receiving from a plurality of brokers, provided with one or more property identifications each with a partial or complete set of the property attributes, a bid to secure a listing broker representation for the sale or rental of a particular property, said bid being associated with bid information; fixed bid/monetary bid; with potential listing broker information;
(i) storing said bid information associated with a property identification and a broker identification in a bid information database; and
(j) communicating said bid information to the owner of the associated property together with a broker identification and broker attributes.

2. A method as in claim 1, wherein each of said sets of property attributes comprise a plurality of individual property attributes, such as a price, a geographical indicator and a physical feature, said property database divided into a plurality of property attribute sectors, wherein each of said individual property attributes is dedicated to storing one of said individual property attributes.

3. A method as in claim 2, wherein said providing one or more property identifications each with a partial or complete set of the property attributes associated with each provided property identification to brokers is performed by receiving from a searching broker a number of search criteria indicating searching broker selected individual property attributes and searching broker selected qualitative and/or quantitative characteristics, searching said property database and identifying potential properties of interest to the searching broker.
